(19) United States
(12) Patent Application Publication
(10) Pub. No.: US 2013/0258224 A1
(43) Pub. Date: Oct. 3, 2013

(54) APPARATUS AND METHOD FOR CONTROLLING DOT INVERSION IN LIQUID CRYSTAL DISPLAY DEVICE

(71) Applicant: DONGBU HITEK CO., LTD., Gyeonggi-do (KR)

(72) Inventors: Seung nam Park, Gyeonggi-do (KR); Jongcheol Kim, Gyeonggi-do (KR)

(73) Assignee: Dongbu HiTek Co., Ltd., Gyeonggi-do (KR)

(21) Appl. No.: 13/768,281

(22) Filed: Feb. 15, 2013

(30) Foreign Application Priority Data
Apr. 2, 2012 (KR) 10-2012-0033731

(51) Int. Cl. G02F 1/133

(52) U.S. Cl. CPC G02F 1/13306
USPC 349/41

(57) ABSTRACT

An apparatus that controls dot inversion in a liquid crystal display device. The apparatus includes a ground switch unit to alternately output positive and negative data voltages on positive and negative voltage lines. The ground switch unit performs a switching operation for a pre-charge of a ground voltage when the positive and negative data voltages are alternated with each other. The apparatus includes a positive switch unit to perform an alternate switching operation depending on the combination of first switching and body voltages to supply the positive data voltage to a sub-pixel, and a negative switch unit to perform an inverse-alternate switching operation depending on the combination of second switching and body voltages to supply the negative data voltage to the sub-pixel.

The present application claims priority under 35 U.S.C. 119 and 35 U.S.C. 365 to Korean Patent Application No. 10-2012-0033731 (filed on Apr. 2, 2012), which is hereby incorporated by reference in its entirety.

### BACKGROUND

LCD devices may be used as display panels (e.g. monitors) of electrical appliances, portable appliances and other relevant devices. An LCD device may include a liquid crystal layer interposed between two substrates. An LCD device may control the intensity of an electrical field supplied to the liquid crystal layer and adjusts light quantity transmitting through the substrates to display images.

If an electric field with the same polarity is continuously supplied to the liquid crystal layer in an LCD device, ionic impurities within the liquid crystal layer may be deposited due to characteristics of the liquid crystal material. The deposited ionic impurities may cause pixel electrodes and opposite electrodes thereto to be electrically and chemically changed with potentially undesirable characteristics (e.g. brightness deterioration and/or residual image appearances on an associated display screen).

LCD devices may be driven to periodically invert the polarity of the electric field supplied to the liquid crystal layer, which may be referred to as inversion mode. Different example types of inversion modes are a frame inversion mode, a line inversion mode, a column inversion mode, a dot inversion mode, and/or other relevant inversion modes. A dot inversion mode may be a one dot inversion mode, a two dot inversion mode, a four dot inversion mode and/or another dot inversion mode.

Example FIG. 1 illustrates a circuit diagram of a data driver of an LCD device in accordance with the related art, and FIG. 2 illustrates a timing diagram for signals which are used to drive the transmission gates shown in FIG. 1. The data driver may include at least one of a plurality of registers R1 to R6, a plurality of selectors PS1 to PS3 and NS1 to NS3, a plurality of voltage buffer amplifiers PB1 to PB3 and NB1 to NB3, and/or a transmission gate 100 configured with a plurality of transistors.

In the data driver, the transmission gate 100 may be used to realize the dot inversion mode. The transmission gate 100 may include a plurality of dot inversion control apparatuses. Each of the dot inversion control apparatuses may generate a positive or negative data voltage and supply the data voltage to a sub-pixel in order to perform the dot inversion. For example, a dot inversion control apparatus may include one pair of switch elements I and J coupled between a single output terminal T1 and two input terminals which are connected to the voltage buffer amplifiers PB1 and NB1.

The dot inversion control apparatus may switch the positive and negative data voltages supplied from the two voltage buffer amplifiers PB1 and NB1 using the two switch elements I and J. In order to control turning-on/off operations of the switch elements I and J, gate voltages to turn-on/off the switch elements I and J may need to be higher than the positive data voltage from the voltage buffer amplifier PB1, but lower than the negative data voltage from the voltage buffer amplifier NB1. To meet these requirements, the dot inversion control apparatus may employs high voltage switch elements and/or high voltage transistors.

However, the high voltage switch elements used in the dot inversion control apparatus may have a large medium length and a low saturation current Idsat due to related art manufacturing processes. Complications in reconciling design rules in the related art may relate to high voltage switch elements that must be larger than a medium voltage switch element.

### SUMMARY

Embodiments relate to an apparatus and method for controlling dot inversion in a liquid crystal display device. In embodiments, an apparatus for controlling dot inversion in a liquid crystal display device may include at least one of: (1) A ground switch unit configured to alternately output positive and negative data voltages on positive and negative voltage lines, in accordance with embodiments. In embodiments, the ground switch unit performs a switching operation for a pre-charge of a ground voltage when the positive and negative data voltages are alternated with each other. (2) A positive switch unit configured to perform an alternate switching operation depending on the combination of first switching and body voltages to supply the positive data voltage to a sub-pixel, in accordance with embodiments. (3) A negative switch unit configured to perform an inverse-alternate switching operation depending on the combination of second switching and body voltages to supply the negative data voltage to the sub-pixel, in accordance with embodiments.

In embodiments, a method for controlling dot inversion in a liquid crystal display device may perform at least one of: (1) Performing an alternate switching operation depending on the combination of first switching and body voltages to supply a positive data voltage to a sub-pixel. (2) Performing an inverse-alternate switching operation depending on the combination of second switching and body voltages to supply a negative data voltage to the sub-pixel.

In embodiments, an apparatus for controlling dot inversion in a liquid crystal display device may include at least one of the following: (1) A reference voltage generator configured to selectively generate a positive data voltage, a negative data voltage, at least one sub-positive voltage higher than a ground voltage but lower than the positive data voltage, and at least one sub-negative voltage lower than the ground voltage but higher than the negative data voltage. (2) A ground switch unit configured to alternately output the positive data voltage, the sub-positive voltage, the negative data voltage and the sub-negative voltage, wherein the ground switch unit performs a switching operation for a pre-charge of a ground voltage when the sub-positive and sub-negative voltages are alternated with each other. (3) A positive switch unit configured to perform an alternate switching operation depending on the combination of first switching and body voltages to supply one of the positive data voltage and the sub-positive voltage to a sub-pixel. (4) A negative switch unit configured to perform an inverse-alternate switching operation depending on the combination of second switching and body voltages to supply one of the negative data voltage and the sub-negative voltage to the sub-pixel.

In embodiments, a method for controlling dot inversion in a liquid crystal display device may include supplying to a sub-pixel a plurality of medium voltages inclusive of a ground voltage between a positive data voltage and a negative data voltage when the positive data voltage and the negative data voltage are alternately inverted.

In embodiments, a method for controlling dot inversion in a liquid crystal display device may include at least one of: (1) Supplying a positive data voltage, a sub-positive voltage, a ground voltage, and a sub-negative voltage in these sequences to a sub-pixel when the positive data voltage and the negative data voltage are alternately inverted, in accordance with embodiments. (2) Supplying a negative data voltage, a sub-negative data voltage, a ground voltage, and a sub-positive data voltage in these sequences to a sub-pixel when the positive data voltage and the negative data voltage are alternately inverted, in accordance with embodiments. In embodiments, the sub-positive data voltage is higher than the ground voltage but lower than the positive data voltage, and the sub-negative data voltage is higher than the negative data voltage but lower than the ground voltage. In embodiments, the sub-negative data voltage is higher than the negative data voltage but lower than the ground voltage, and the sub-positive data voltage is higher than the ground voltage but lower than the positive data voltage.

In embodiments, a method for controlling dot inversion in a liquid crystal display device may perform at least one of: (1) Supplying a positive data voltage to a sub-pixel by an alternate switching operation depending on the combination of first switching and body voltages. (2) Supplying a sub-positive voltage, which is lower than the positive data voltage but higher than a ground voltage, to the sub-pixel by the alternate switching operation depending on the combination of the first switching and body voltages. (3) Performing a switching operation for a pre-charge of the ground voltage when the sub-positive voltage does not supplied to the sub-pixel. (4) Supplying a sub-negative voltage, which is higher than a negative data voltage but lower than the ground voltage, to the sub-pixel by the inverse-alternate switching operation depending on the combination of second switching and body voltages. (5) Supplying the negative data voltage to the sub-pixel by the inverse-alternate switching operation depending on the combination of the second switching and body voltages.

In embodiments, Vgs, Vds, Vgb, or Vsd supplied to the transistors in the dot inversion control apparatus is changed with a level of the medium voltage transistors by alternate switching operation or inverse-alternate switching operation through the combination of the switching and body voltages, and therefore the data driver is fabricated with a small chip size. Further, a high voltage for a switching operation is achieved by a medium voltage instead of a high voltage and therefore a power consumption is reduced and EMI (electromagnetic wave interference) is prevented.

### DRAWINGS

The above and other objects and features of embodiments will become apparent from the following description of embodiments, given in conjunction with the accompanying drawings, in which:

FIG. 1 illustrates a circuit diagram of a data driver of an LCD device, in accordance with the related art.

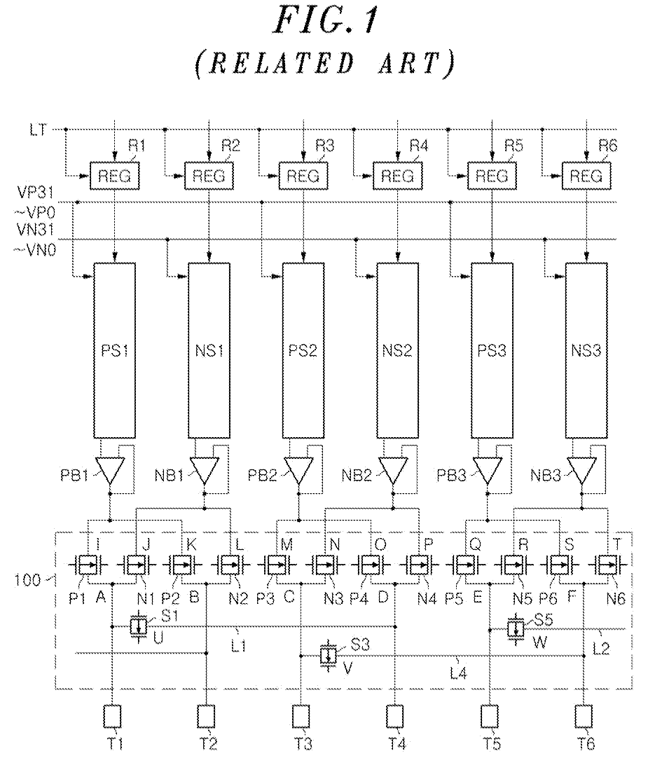

FIG. 2 is a timing diagram for signal which is used to drive the transmission gate shown in FIG. 1, in accordance with the related art.

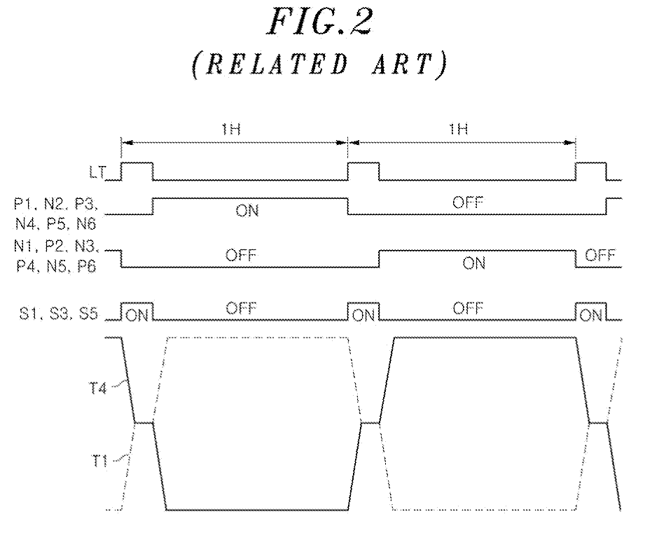

FIG. 3 illustrates a circuit diagram of a dot inversion control apparatus of an LCD device, in accordance with embodiments.

FIG. 4 illustrates timing diagram for signals which are used to drive the dot inversion control apparatus of FIG. 3, in accordance with embodiments.

FIG. 5 illustrates a circuit diagram of a dot inversion control apparatus of an LCD device, in accordance with embodiments.

FIG. 6 illustrates a timing diagram for signals which are used to drive the dot inversion control apparatus of FIG. 5, in accordance with embodiments.

### DESCRIPTION

Embodiments are described in detail with reference to the accompanying drawings so that they can be readily implemented by those skilled in the art.

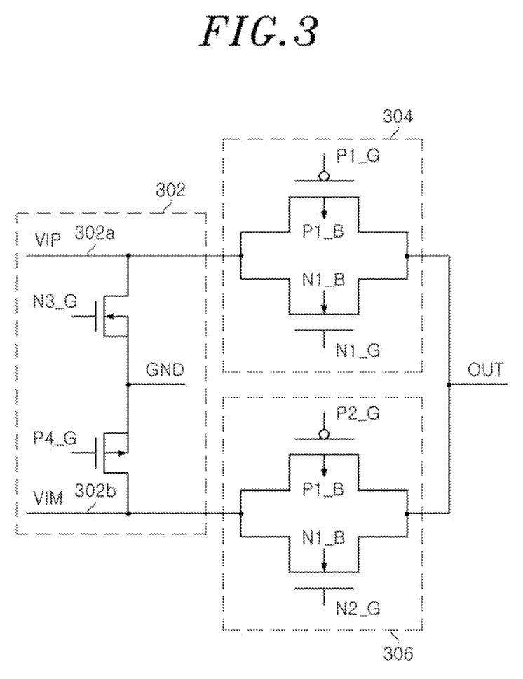

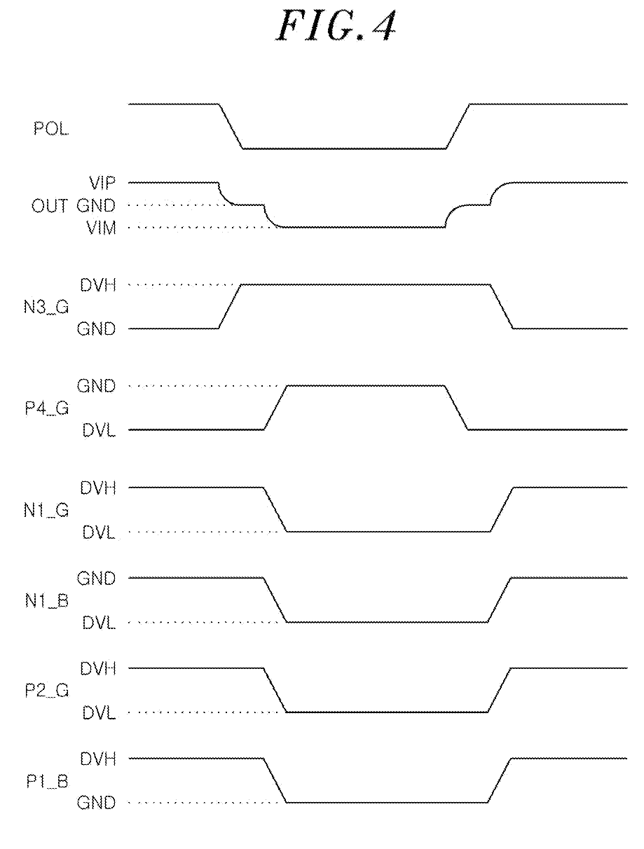

FIG. 3 illustrates a circuit diagram of a dot inversion control apparatus of an LCD device in accordance with embodiments. FIG. 4 is a timing diagram for signals which are used to drive the dot inversion control apparatus of FIG. 3, in accordance with embodiments. The dot inversion control apparatus may include a ground (GND) switch element 302, a positive switch unit 304 and a negative switch unit 306.

As illustrated in FIG. 3, the GND switch unit 302 may perform a switching operation for pre-charging a ground voltage when a data voltage is changed between positive and negative data voltages (e.g. the polarity of the data voltage is inverted) to alternately output the positive data voltage and the negative data voltage, in accordance with embodiments. The GND switch unit 302 may include a pair of tri-electrode transistors N3 and P4 serially connected between a positive data voltage line 302a and a negative data voltage line 302b. The two tri-electrode transistors may have different conductive properties from each other. For example, the pair of tri-electrode transistors may include an NMOS transistor N3 and a PMOS transistor P4. In the GND switch unit 302, the NMOS transistor N3 may maintain a turned-off state and the PMOS transistor P4 may maintain a turned-on state when the positive data voltage is output. In other circumstances, the NMOS transistor N3 may maintain a turned-on state and the PMOS transistor P4 is in the turned-off state when the negative data voltage is output.

The positive switch unit 304 may perform an alternate switching operation in accordance with the combination of switching and body voltages. The positive switch unit may supply the positive data voltage VIP, which is input to the GND switch unit 302, to a sub-pixel (e.g. one of red R, green G and B sub-pixels). In embodiments, the switching and body voltages supplied to the positive switch unit 304 are set to be no more than a predetermined maximum resistant voltage of the positive data voltage VIP.

The positive switch electrode 304 may include a pair of four-electrode transistors P1 and N1, which may be connected in parallel to each other. The two four-electrode transistors have different conductive properties from each other. For example, the two four-electrode transistors may be a PMOS transistor P1 and a NMOS transistor N1.

When the positive data voltage VIP is output, the pair of four-electrode transistors P1 and N1 may maintain the turned-on state. A voltage of DVH level corresponding to the turning-on level may be supplied to a gate electrode N1_G of the NMOS transistor N1, a GND voltage may be supplied to a body electrode N1_B of the NMOS transistor N1, and/or the voltage of the DVH level may be supplied to a body electrode P1_B of the PMOS transistor P1, as illustrated in FIG. 4, in accordance with embodiments. A gate electrode P1_G of the PMOS transistor P1 may be connected to GND, regardless of a polarity inversion signal POL. The two transistors P1 and N1 of the positive switch unit 304 may maintain the turned-on state in order to output the positive data voltage VIP, two transistors P2 and N2 of the negative switch unit 306 maintain the turned-off state. The negative data voltage VIM supplied to the two transistors P2 and N2 of the negative switch unit 306 may become 0V.

The negative switch unit 306 may perform an inverse-alternate switching operation in accordance with the combination of the switching and body voltages. The negative switch unit 306 may supply the negative data voltage VIM, which is input to the GND switch unit 302, to the sub-pixel. In embodiments, the switching and body voltages supplied to the negative switch unit 306 are set to be no more than a predetermined maximum resistant voltage of the negative data voltage VIM.

In embodiments, in an inverse-alternate switching operation when the two transistor P2 and N2 of the negative switch unit 306 are in the turned-off state when the two transistor P1 and N1 of the positive switch unit 304 maintain the turned-on state to output the VIP voltage. Likewise, when the two transistor P1 and N1 of the positive switch unit 304 are in the turned-off state when the two transistor P2 and N2 of the negative switch unit 306 maintain the turned-on state to output the VIM voltage, in accordance with embodiments. In embodiments, the two transistors P2 and N2 perform the inverse-alternate switching mode when the two transistors P1 and N1 are switched in the alternate switching mode.

The negative switch electrode 306 may include a pair of four-electrode transistors P2 and N2 which are connected parallel to each other, similar to in the positive switch unit 304. The two four-electrode transistors P2 and N2 may have different conductive properties from each other, in accordance with embodiments. In embodiments, the two four-electrode transistors may be a PMOS transistor P2 and a NMOS transistor N2.

When the negative data voltage VIM is output, the pair of four-electrode transistors P2 and N2 may be maintained in a turned-on state. The GND voltage may be supplied to a body electrode of the PMOS transistor P2, a voltage of DVL level corresponding to the turning-on level may be supplied to a gate electrode P2_G of the PMOS transistor P2 and a body electrode N2_B of the NMOS transistor N2, as shown in FIG. 4, in accordance with embodiments. A gate electrode N2_G of the NMOS transistor N2 may be connected to the GND, regardless of a polarity inversion signal POL. The two transistors P2 and N2 of the negative switch unit 306 maintain the turned-on state in order to output the negative data voltage VIM, while the two transistors P1 and N1 of the positive switch unit 304 maintain the turned-off state. The positive data voltage VIP supplied to the two transistors P1 and N1 of the positive switch unit 304 may become 0V.

As illustrated in FIG. 4, when the GND switch unit generates the polarity inversion signal POL having the high level, the positive switch unit 304 may produce the positive data voltage VIP at the output terminal OUT via the pre-charged voltage with a GND level. Alternatively, when the GND switch unit generates the polarity inversion signal POL having the low level, the negative switch unit 306 may produce the negative data voltage VIM with a negative level on the output terminal OUT via the pre-charged voltage with the GND level.

For convenience of explanation and improvement of understanding and as a non-limiting example, it may be assumed that the transistors used in the switch elements 302, 304 and 306 have a resistant voltage of 6V. In this case, “DVH” and “DVL” may be defined as follows:

VIP<DVH<6V: “DVH” may be the highest voltage among the positive voltages;

−6V<DVL<VIM: “DVL” may be the lowest voltage among the negative voltages;

0V<VIP<6V: “VIP” is the positive data voltage on the output terminal OUT when the polarity inversion signal POL has the high level; and

−6V<VIM<0V: “VIM” is the negative data voltage on the output terminal OUT when the polarity inversion signal POL has the low level.

In embodiments, when the polarity inversion signal has the high level, the highest voltage DVH is supplied to the gate electrodes N1_G and P2_G of the NMOS and PMOS transistors N1 and P2 and the body electrode P1_B of the PMOS transistor P1. The GND voltage is supplied to the body electrode N1_B of the NMOS transistor N1, in accordance with embodiments. The GND voltage is supplied to the gate electrode N3_G of the NMOS transistor N3 and the lowest voltage DVL is supplied to the gate electrode P4_G of the PMOS transistor P4, and therefore the negative data voltage VIM supplied to the PMOS and NMOS transistors P2 and N2 becomes 0V, in accordance with embodiments. The gate electrodes P1_G and N2_G of the PMOS and NMOS transistor P1 and N2 are connected to the GND, regardless of the polarity inversion signal POL, in accordance with embodiments.

In embodiments, when the polarity inversion signal POL has the high level, the PMOS and NMOS transistors P1 and N1 are turned-on and transmit the positive data voltage VIP to the sub-pixel via the output terminal OUT. For example, in embodiments, if the polarity inversion signal POL changes from the high level to the low level in a state that the positive data voltage VIP, the negative data voltage VIM and the output voltage of the output terminal OUT have 5V, −5V and 5V (VIP=5V, VIM=−5V and OUT=5V), the voltage of the gate electrode N3_G of the NMOS transistor N3 rises to the highest voltage and therefore the output terminal OUT is discharged to the GND voltage.

For example, in embodiments, a gate-source voltage, a gate-drain voltage, a body-source voltage and a body-drain voltage of the PMOS transistor P1 may become 0V, −5V, −6V and −1V, respectively (e.g. Vgs=0V, Vgd=−5V, Vbs=−6V and Vbd=−1). The gate-source voltage, the gate-drain voltage, the body-source voltage and the body-drain voltage of the NMOS transistor N1 may have 6V, 1V, 0V and −5V, respectively (e.g. Vgs=6V, Vgd=1V, Vbs=0V and Vbd=−5V). Alternatively, the gate-source voltage, the gate-drain voltage, the body-source voltage and the body-drain voltage of the PMOS transistor P2 have 6V, 1V, 6V and −1V, respectively (e.g. Vgs=6V, Vgd=1V, Vbs=6V and Vbd=−1V). The gate-source voltage, the gate-drain voltage, the body-source voltage and the body-drain voltage of the NMOS transistor N2 also have 0V, −5V, 0V and −5V, respectively (e.g. Vgs=0V, Vgd=−5V, Vbs=0V and Vbd=−1V). In embodiments, the resistant voltages of the above transistors are no more than a breakdown voltage of a medium voltage transistor. Therefore, in embodiments, the dot inversion control apparatus may be implemented with medium voltage transistors (or medium voltage switch elements).

After the pre-charge of the GND voltage is completed, the output voltage on the output terminal OUT may change into the negative voltage VIM. The GND voltage of the lowest voltage DVL is supplied to the gate electrode P4_G of the PMOS transistor P4 and the lowest voltage DVL is supplied to the gate electrode N1_G of the NMOS transistor N1. The lowest voltage DVL and the GND voltage is supplied to the body electrodes N1_B and P1_B of the NMOS and PMOS transistor N1 and P1. The PMOS and NMOS transistors P1 and N1 of the positive switch unit 304 are turned-off.

When a gate-source voltage, a gate-drain voltage, a body-source voltage and a body-drain voltage of the PMOS transistor P1 become 0V, −5V, 0V and −5V, respectively (e.g. Vgs=0V, Vgd=−5V, Vbs=0V and Vbd=−5). The gate-source voltage, the gate-drain voltage, the body-source voltage and the body-drain voltage of the NMOS transistor N1 have −6V, −1V, −6V and −1V, respectively (e.g. Vgs=−6V, Vgd=−1V, Vbs=−6V and Vbd=−1V). Alternatively, when the gate-source voltage, the gate-drain voltage, the body-source voltage and the body-drain voltage of the PMOS transistor P2 have −1V, −1V, −5V and −5V, respectively (e.g. Vgs=−1V, Vgd=−1V, Vbs=−5V and Vbd=−5V). The gate-source voltage, the gate-drain voltage, the body-source voltage and the body-drain voltage of the NMOS transistor N2 also have −5V, −5V, −1V and −1V, respectively (e.g. Vgs=−5V, Vgd=−5V, Vbs=−1V and Vbd=−1V). In embodiments, the resistant voltages of the above transistors are no more than a breakdown voltage of a medium voltage transistor. Therefore, in embodiments, the dot inversion control apparatus may be implemented with medium voltage transistors (or medium voltage switch elements).

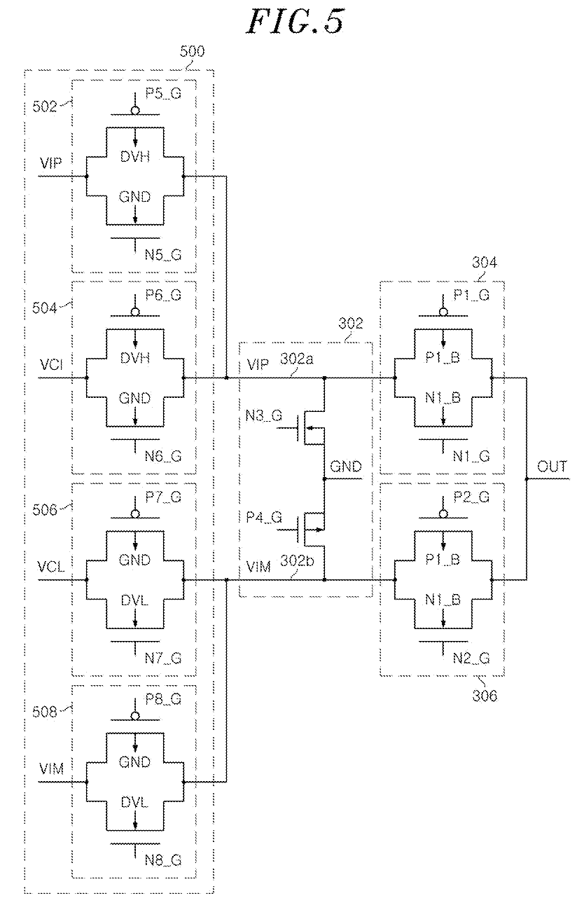

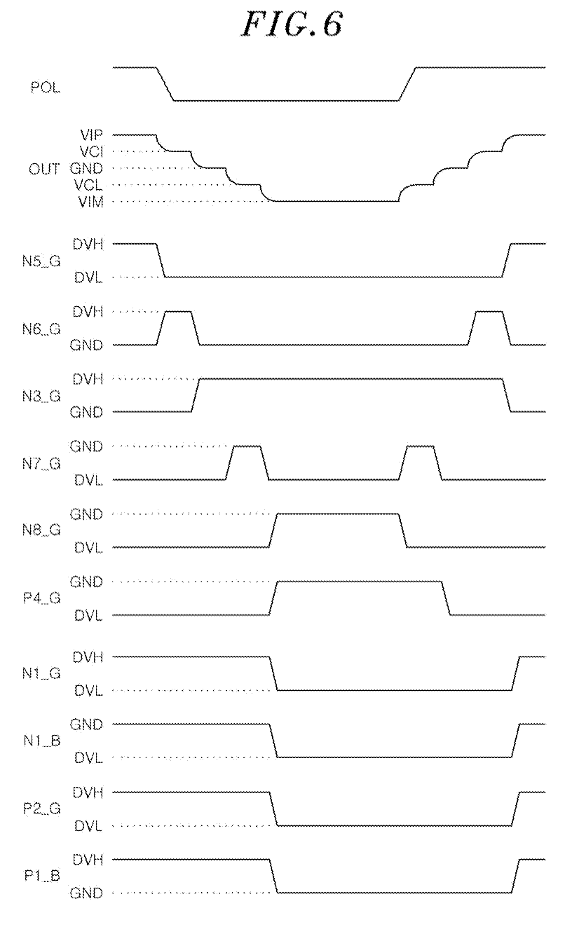

FIG. 5 illustrates a circuit diagram of a dot inversion control apparatus of an LCD device in accordance with embodiments. FIG. 6 illustrates a timing diagram for signals which are used to drive the dot inversion control apparatus of FIG. 5, in accordance with embodiments.

The dot inversion control apparatus of embodiment illustrated in FIG. 5 includes a reference voltage generator 500 connected to the positive and negative data voltage lines 302a and 302b. In embodiments, the dot inversion control apparatus may have similar configurations in whole or in part (e.g. the GND, positive and negative switch units 302, 304 and 306) as that illustrated in other embodiments.

Embodiments include the reference voltage generator 500 configured with first to fourth switch elements 502 to 508. The reference voltage generator 500 may include four switch elements 502, 504, 506 and 508 and selectively generates one of a positive data voltage, a sub-positive voltage, a negative data voltage and a sub-negative voltage.

The first switch element 502 may include a pair of four-electrode transistors P5 and N5 which are connected in parallel to each other and have different conductive properties from each other, as an example embodiment. The first switch element 502 may generate a preset positive data voltage VIP and supply the positive data voltage VIP to the GND switch unit 302 on the positive voltage line 302a. The second switch element 504 may include a pair of four-electrode transistors P6 and N6 which are connected in parallel to each other and have different conductive properties from each other, as an example embodiments. The second switch element 504 may generate a preset sub-positive voltage VCI and supply the sub-positive voltage VCI to the GND switch unit 302 on the positive voltage line 302a. The sub-positive voltage VCI has a positive voltage value which is relatively low compared to the positive data voltage VIP but higher than the GND voltage. For example, if the positive data voltage VIP is 5V, the sub-positive voltage VCI may be about 2.5V corresponding to an intermediate value between 5V and the GND voltage.

The four switch element 508 may include a pair of four-electrode transistors P8 and N8 which are connected in parallel to each other and have different conductive properties from each other, as an example embodiment. The fourth switch element 508 may generate a preset negative data voltage VIM and supply the negative data voltage VIM to the GND switch unit 302 on the negative voltage line 302b. The third switch element 506 may include a pair of four-electrode transistors P7 and N7 which are connected in parallel to each other and have different conductive properties from each other, as an example embodiment. The third switch element 506 may generate a preset sub-negative voltage VCL and supply the sub-negative voltage VCL to the GND switch unit 302 on the negative voltage line 302b. The sub-negative voltage VCL may have a negative voltage value which is relatively high compared to the negative data voltage VIM but lower than the GND voltage. For example, if the negative data voltage VIM is −5V, the sub-negative voltage VCL may be about −2.5V corresponding to an intermediate value between −5V and the GND voltage.

In embodiments, the pair of four-electrode transistors included in each of the first to fourth switch elements 502, 504, 506 and 508 may be configured with a pair of PMOS and NMOS transistors.

In operation, in embodiments, for example, when the reference voltage generator 500 outputs the positive data voltage VIP on the positive data voltage line 302a, the two transistors P5 and N5 included in the first switch element 502 are turned-on and all the remaining six transistors included in the second to fourth switch elements 504, 506 and 508 are in the turned-off state.

For example, when the reference voltage generator 500 outputs the sub-positive voltage VCI on the positive voltage line 302a, the two transistors P6 and N6 included in the second switch element 504 are turned-on and all the remaining six transistors included in the first, third and fourth switch elements 502, 506 and 508 are in the turned-off state.

For example, when the reference voltage generator 500 outputs the sub-negative voltage VCL on the negative voltage line 302b, the two transistors P7 and N7 included in the third switch element 506 are turned-on and all the remaining six transistors included in the first, second and fourth switch elements 502, 504 and 508 are in the turned-off state.

For example, when the reference voltage generator 500 outputs the negative data voltage VIM on the negative voltage line 302b, the two transistors P8 and N8 included in the fourth switch element 508 are turned-on and all the remaining six transistors included in the first to third switch elements 502, 504 and 506 are in the turned-off state.

In embodiments, the GND switch unit 302 including the pair of transistors P3 and N3, which are serially connected between the positive and negative voltage lines 302a and 302b and have different conductive properties from each other, sequentially outputs the positive data voltage VIP, the sub-positive voltage VCI, the sub-negative voltage VCL and the negative data voltage VIM. In embodiments, the GND switch unit 302 performs the switching operation for pre-charging the GND voltage when the voltage on the output terminal OUT is switched between the sub-positive voltage VCI and the sub-negative voltage VCL.

The positive switch unit 304 may be switched into the turned-on state only when the positive data voltage VIP or the sub-positive voltage VCI is provided. The negative switch unit 306 may be switched into the turned-on state only when the negative data voltage VIM or the sub-negative voltage VCL is applied. Therefore, for example, as shown in FIG. 6, a voltage supply of a sequence of “VIM→VCL→GND→VCI→VIP” for a preset period may be performed on the sub-pixel when the negative data voltage is changed to the positive data voltage. For example, in embodiments, assuming that the positive and negative data voltages VIP and VIM have 5V and −5V, respectively, a sequence of “−5V→−2.5V→GND→2.5V→5V” may be supplied to the sub-pixel when the negative data voltage is switched to the positive data voltage. In embodiments, the switching and body voltages supplied to the positive switch unit 304 may be set to be no more than a preset maximum resistant voltage of the positive data voltage VIP or the sub-positive voltage VCI. Similarly, in embodiments, the switching and body voltages supplied to the negative switch unit 306 are set to be no more than a preset maximum resistant voltage of the negative data voltage VIM or the sub-negative voltage VCL.

The operation that the inversion of the (positive and negative) data voltages in their polarities going through the medium voltages of VCL, GND and VCI is to reduce power consumption, compared to a stage charge sharing or the GND pre-charging.

Although it has been described that the three medium voltages of “VCL, GND and VCI” are employed in embodiments, it is provided only by way of example for convenience of explanation and improvement of understanding and the embodiment is not limited thereto. It is understood that the medium voltages may be increased at 3, 5, 7, 9 or others amounts, as needed. In embodiments, when the polarity of the data voltage supplied to the respective sub-pixel is inverted, a plurality of preset medium voltages including the GND voltage may be supplied between the positive data voltage and the negative data voltage.

In embodiments, the dot inversion control apparatuses may be supplied to not only the one-dot inversion mode but also every inversion mode, such as a two-dot inversion mode, a three-dot inversion mode, a four-dot inversion mode or other inversion modes.

While embodiments have been shown and described, it will be understood by those skilled in the art that various changes and modification may be made without departing the scope of the embodiments as defined in the following claims.

What is claimed is:

1. An apparatus comprising:
a ground switch unit configured to alternately output positive and negative data voltages on positive and negative voltage lines, wherein the ground switch unit performs a switching operation for a pre-charge of a ground voltage when the positive and negative data voltages are alternated with each other;
a positive switch unit configured to perform an alternate switching operation depending on the combination of first switching and body voltages to supply the positive data voltage to a sub-pixel; and
a negative switch unit configured to perform an inverse-alternate switching operation depending on the combination of second switching and body voltages to supply the negative data voltage to the sub-pixel.

2. The apparatus of claim 1, wherein the apparatus is configured for controlling dot inversion in a liquid crystal display device.

3. The apparatus of claim 1, wherein the ground switch unit includes a pair of tri-electrode transistors serially connected between the positive and negative voltage lines.

4. The apparatus of claim 3, wherein the tri-electrode transistors have different conductive properties from each other.

5. The apparatus of claim 1, wherein:
the first switching and body voltages are set to be no more than a preset maximum resistant voltage of the positive data voltage; and
the second switching and body voltages are set to be no more than a preset maximum resistant voltage of the negative data voltage.

6. The apparatus of claim 1, wherein each of the positive and negative switch units comprises a pair of transistors which are connected to each other and have different conductive properties.

7. A method of controlling dot inversion in a liquid crystal display device, the method comprising:
performing an alternate switching operation depending on the combination of first switching and body voltages to supply a positive data voltage to a sub-pixel; and
performing an inverse-alternate switching operation depending on the combination of second switching and body voltages to supply a negative data voltage to the sub-pixel.

8. The method of claim 7, further comprising performing a switching operation for a pre-charge of a ground voltage when the positive and negative data voltages are alternated with each other.

9. The method of claim 7, wherein:
the first switching and body voltages are set to be no more than a preset maximum resistant voltage of the positive data voltage; and
the second switching and body voltages are set to be no more than a preset maximum resistant voltage of the negative data voltage.

10. An apparatus configured to control dot inversion in a liquid crystal display device, the apparatus comprising:
a reference voltage generator configured to selectively generate a positive data voltage, a negative data voltage, at least one sub-positive voltage higher than a ground voltage but lower than the positive data voltage, and at least one sub-negative voltage lower than the ground voltage and higher than the negative data voltage;
a ground switch unit configured to alternately output the positive data voltage, the sub-positive voltage, the negative data voltage and the sub-negative voltage, wherein the ground switch unit performs a switching operation for a pre-charge of a ground voltage when the sub-positive and sub-negative data voltages are alternated with each other;
a positive switch unit configured to perform an alternate switching operation depending on the combination of first switching and body voltages to supply one of the positive data voltage and the sub-positive voltage to a sub-pixel; and
a negative switch unit configured to perform an inverse-alternate switching operation depending on the combination of second switching and body voltages to supply one of the negative data voltage and the sub-negative voltage to the sub-pixel.

11. The apparatus of claim 10, wherein the reference voltage generator comprises:
a first switch element having a pair of four-electrode transistors, wherein the first switch element is configured to generate the positive data voltage;
a second switch element having a pair of four-electrode transistors, wherein the second switch element is configured to generate the sub-positive voltage;
a third switch element having a pair of four-electrode transistors, wherein the third switch element is configured to generate the negative data voltage; and
a fourth switch element having a pair of four-electrode transistors, wherein the fourth switch element is configured to generate the sub-negative voltage.

12. The apparatus of claim 10, wherein the two transistors comprised in each of the transistor pairs are connected to each other and have different conductive properties from each other.

13. The apparatus of claim 10, wherein:
the ground switch unit comprises a pair of transistors having different conductive properties from each other;
the pair of transistors are serially connected between (1) a positive voltage line on which the positive data voltage and the sub-positive voltage are output and (2) a negative voltage line on which the negative data voltage and the sub-negative voltage are output.

14. The apparatus of claim 10, wherein the first switching and body voltages are set to be no more than a preset maximum resistant voltage of the positive data voltage or the sub-positive voltage.

15. The apparatus of claim 10, wherein the sub-positive voltage has a medium value between the positive data voltage and the ground voltage.

16. The apparatus of claim 10, wherein the sub-negative voltage has a medium value between the negative data voltage and the ground voltage.

17. A method of controlling dot inversion in a liquid crystal display device, the method comprising supplying to a sub-pixel a plurality of medium voltages inclusive of a ground voltage between a positive data voltage and a negative data voltage when the positive data voltage and the negative data voltage are alternately inverted.

18. A method of controlling dot inversion in a liquid crystal display device, the method comprising:
successively supplying a positive data voltage, a sub-positive voltage, a ground voltage, and a sub-negative voltage to a sub-pixel when the positive data voltage is alternately inverted to the negative data voltage; and
successively supplying a negative data voltage, a sub-negative data voltage, a ground voltage, and a sub-positive data voltage to a sub-pixel when the negative data voltage is alternately inverted to the positive data voltage,
wherein the sub-positive data voltage is higher than the ground voltage but lower than the positive data voltage, and the sub-negative data voltage is higher than the negative data voltage but lower than the ground voltage; and
wherein the sub-negative data voltage is higher than the negative data voltage but lower than the ground voltage, and the sub-positive data voltage is higher than the ground voltage but lower than the positive data voltage.

19. A method of controlling dot inversion in a liquid crystal display device, the method comprising:
supplying a positive data voltage to a sub-pixel by an alternate switching operation depending on the combination of first switching and body voltages;
supplying a sub-positive voltage, which is lower than the positive data voltage but higher than a ground voltage, to the sub-pixel by the alternate switching operation depending on the combination of the first switching and body voltages;
performing a switching operation for a pre-charge of the ground voltage when the sub-positive voltage does not supplied to the sub-pixel;
supplying a sub-negative voltage, which is higher than a negative data voltage but lower than the ground voltage, to the sub-pixel by the inverse-alternate switching operation depending on the combination of second switching and body voltages; and
supplying the negative data voltage to the sub-pixel by the inverse-alternate switching operation depending on the combination of the second switching and body voltages.

20. The method of claim 19, wherein:
the first switching and body voltages are set to be no more than a preset maximum resistant voltage of the positive data voltage or the sub-positive voltage; and
the second switching and body voltages are set to be no more than a preset maximum resistant voltage of the negative data voltage or the sub-negative voltage.
